(19) United States
(12) Patent Application Publication
(10) Pub. No.: US 2011/0097592 A1
(43) Pub. Date: Apr. 28, 2011

(54) MULTI-LAYER STRUCTURE INCLUDING A BUFFER LAYER

(76) Inventor: Ching-Tu WANG, Taoyuan County (TW)

(21) Appl. No.: 12/884,883

(22) Filed: Sep. 17, 2010

(30) Foreign Application Priority Data
Oct. 23, 2009 (TW) 098135919

(51) Int. Cl. B32B 27/08; B29C 45/14; B31B 1/64

(52) U.S. Cl. 428/515; 264/328.14; 156/60

(57) ABSTRACT

A multi-layer structure including a buffer layer is to couple with a substrate in a die. The multi-layer structure includes a biological material layer, a bonding layer and a thermoplastic buffer layer. The biological material layer has a first surface attached to the bonding layer. The buffer layer has one side boned with the bonding layer. The buffer layer has a compressed surface to withstand high pressure and be bonded to the substrate. The bonding layer and buffer layer are made of thermoplastic material, and are bonded together firmly through thermal fusion. The compressed surface of the buffer layer directly withstands the injection temperature and pressure exerting to the substrate in the mold, therefore can alleviate the temperature and pressure withstood by the biological material layer. Hence the biological material layer is protected without being damaged in the mold, and bonding between the multi-layer structure and substrate has longer lifespan.

### FIELD OF THE INVENTION

The present invention relates to a multi-layer structure including a buffer layer and particularly to a multi-layer structure including a biological material layer to be coupled with a substrate in a mold and a buffer layer to alleviate high pressure and high temperature in the mold to avert damage of the biological material layer.

### BACKGROUND OF THE INVENTION

Industrial products, in addition to providing desirable performance, also must improve appearance, touch feeling and identification of the product through innovative and aesthetic profile design to enhance product orientation and prices on the market. Many conventional industrial products, such as handsets or notebook computers, have plastic casings. Although some of them are coated with paint to provide shades different from plastics, they still have notable plastic touch feeling. After being used for a period of time or being subjected to abrasion, the paint on the surface is worn away and the plastic surface is exposed. Hence the plastic casing coated with paint generally does not have attractive appearance and desirable tough feeling.

There are also products formed with metal material on the casings. The surface of the casing is simply treated such that metal textures and touch feeling become distinguishing features of the product. For instance, R.O.C. patent No. M346244 entitled “Surface coating structure for casings of electronic devices” discloses a sputtering layer formed on a substrate. The sputtering layer has an oxidation layer on the surface and treated by an anodizing treatment. The sputtering layer can be made of copper, brass, titanium alloy, aluminum or the like. However, the metal material provides limited diversity of color and touch feeling, and also is not elastic and renders cold feeling.

To remedy the aforesaid shortcomings, technique of combining biological material (such as wood, leather or the like) with metal has been developed. For instance, R.O.C. patent No. M321677 entitled “Composite casing structure” discloses a casing consisting of a surface layer and a bottom layer. The surface layer can be formed with patterns through digital or transfer printing. The bottom layer is a metal sheet. A layer of adhesive is provided between the bottom side of the surface layer and the surface of the bottom layer to bond the surface layer and bottom layer together.

However, the biological material boned on the metal surface through the adhesive tends to be peeled off from the edge thereof after a period of time or when being subjected to abrasion or impact. Air bubbles formed by defective bonding may also occur. Other factors such as abrasion also could cause dislocation of the biological material. In short, bonding the biological material through the adhesive with metal or plastics that differ very much in characteristics is prone to be loosened off after a period of time. Moreover, in the event that the biological material and the substrate are formed by pressing and punching, although they might be boned firmly at the beginning, since there is no buffer structure between them to alleviate the impact and high temperature during pressing and punching, the biological material is easily damaged. Moreover, the biological material and substrate have different static stress variations, they tend to be shrunk at different amount after a long duration and result in breaking and forming small cracks that cause peeling off or bulging out on the surface.

### SUMMARY OF THE INVENTION

In view of the biological material bonded with the substrate is easily damaged by injection temperature and pressure in the mold by adopting the conventional techniques and results in separation of the biological material and substrate, an object of the present invention aims to provide a multi-layer structure to prevent the biological material from being damaged by temperature and pressure in a mold, thereby to prolong the lifespan of the multi-layer structure and substrate that are boned together.

The present invention provides a multi-layer structure including a buffer layer, and the multi-layer structure is boned with a substrate in a die. The multi-layer structure includes at least one biological material layer, a bonding layer and a thermoplastic buffer layer. The biological material layer at least has a first surface bonded to the bonding layer. The buffer layer has one side boned with the bonding layer. The buffer layer has a compressed surface to withstand high pressure and be bonded with the substrate by fusion. The bonding layer and buffer layer are made of thermoplastic material, and are bonded together firmly through thermal fusion. The compressed surface of the buffer layer directly withstands the injection temperature and pressure in the mold from the substrate, therefore can alleviate the temperature and pressure sustained by the biological material layer. Hence the biological material layer is protected without being damaged in the mold, and the bonding between the multi-layer structure and the substrate can have a longer lifespan.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a sectional view of the multi-layer structure.

FIG. 2 is a sectional view of the multi-layer structure bonded with the substrate.

FIG. 3 is a sectional view of the multi-layer structure bonded with the substrate in a mold.

### DETAILED DESCRIPTION OF THE PREFERRED EMBODIMENT

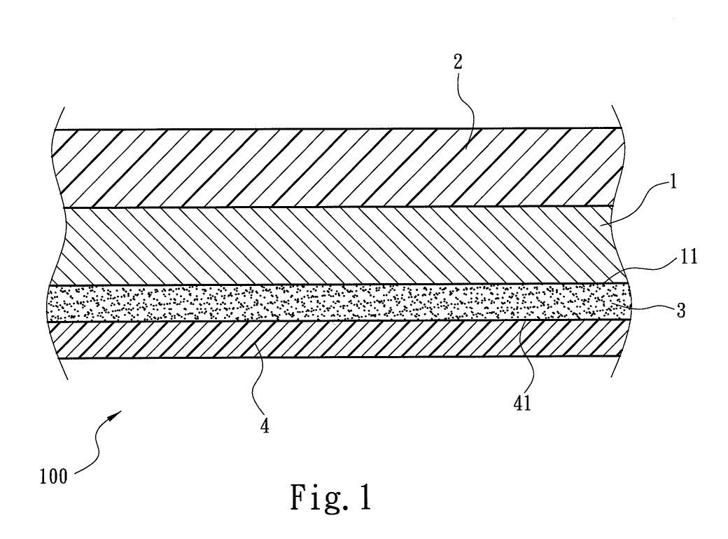

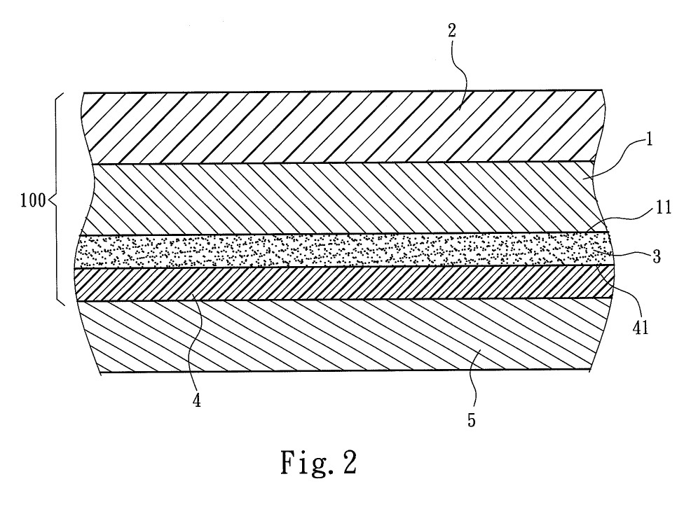

The present invention aims to provide a multi-layer structure including a buffer layer. Referring to FIG. 1, the multi-layer structure 100 at least includes a biological material layer 1 which at least has a first surface 11 to be bonded with a bonding layer 3. The bonding layer 3 is bonded with a thermoplastic buffer layer 4. The buffer layer 4 has a compressed surface to withstand high pressure and be bonded with a substrate 5 by thermal fusion (also referring to FIG. 2). While the buffer layer 4 is made of thermoplastic material, the bonding layer 3 may be a thermo-melting adhesive to cover the biological material layer 1 in a thermal melting condition. With the buffer layer 4 compressed on the bonding layer 3 in the thermal melting condition, they have some portions mixed together on the junction between them. After cooling, a fusion surface 41 is formed between the buffer layer 4 and bonding layer 3. The fusion surface 41 is formed by condensation of the mixture of the bonding layer 3 and buffer layer 4. Hence a strong fusion structure is formed between the buffer layer 4 and bonding layer 3. This can indirectly ensure that the buffer layer 4 is positioned on one side of the biological material layer 1. The buffer layer 4 can be selected from the group consisting of Polycarbonate (PC), Polymethyl Methacrylate (PMMA), modified PMMA, Acrylonitrile Butadiene Styrene (ABS), Polystyrene (PS), propylene-styrene copolymer, Polyvinylchloride (PVC), polyester, and combinations thereof. It is to be noted that material selection for the buffer layer 4 depends on thermal and pressurized fusion requirement for the bonding material to carry out the aforesaid technique. The biological material 1 has a second surface on another side opposite to the first surface 11, and an outer layer 2 attached to the second surface. The outer layer 2 aims to protect the surface of the biological material layer 1 without being damaged when being subjected to high temperature and pressure in a mold. The outer layer 2 can be a fixed film attached to the biological material layer 1, and also can be colored through a dyeing process to provide aesthetic color and luster for the surface of the multi-layer structure 100. In addition, the outer layer 2 may also be a release structure that can be peeled off. After the second surface protects the biological material layer 1 from being damaged by high temperature and pressure, the outer layer 2 can be peeled off, and the second surface can be coated with paint in a spray coating process. The outer layer 2 may be a UV curable monomer or PU film. More specifically, the outer layer 2 can be selected from the group consisting of Polyethylene terephthalate (PET), Polyethylene naphthalate (PEN), Polyethylene glycol-co-cyclohexane-1,4 dimethanol terephthalate (PETG), Thermalplastic polyurethane (TPU), Polyurethane (PU), Polypropylene (PP), Polycarbonate (PC), Amorphous polyethylene terephthalate (A-PET), Polyvinyl chloride (PVC), Acrylic, Methly-methacrylate-styrene (MS), Acrylonitrile-butadiene-styrene copolymer, Polystyrene (PS), Polyoxymethylene (POM), Nylon, and combinations thereof.

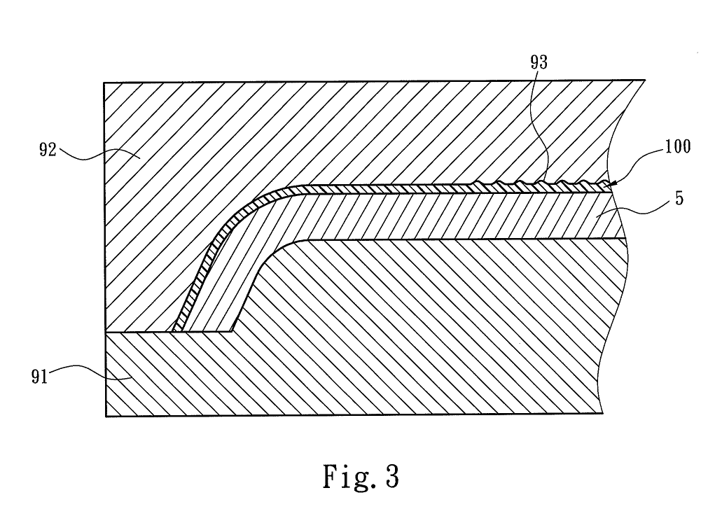

Referring to FIGS. 2 and 3, the multi-layer structure 100 is boned with a substrate 5 in a die. As shown in FIG. 3, the die includes a male core 91 and a female cavity 92. The multi-layer structure 100 is positioned on the female cavity 92 in advance, then the male core 91 and the female cavity 92 are coupled together to form a closed chamber to inject the substrate 5 onto the multi-layer structure 100 at high pressure and temperature. The injection temperature of the substrate 5 is ranged from 200° C. to 300° C., and the pressure in the mold is ranged from 180 tons to 500 tons. Also referring to FIG. 2, with the substrate 5 injected and formed on the buffer layer 4, the thermoplastic buffer layer 4 is fused closely with the substrate 5 under the high temperature and pressure. Meanwhile, the buffer layer 4 withstands the pressure and temperature first when the substrate 5 is injected onto the multi-layer structure 100; then the pressure and temperature are distributed to other layers of the multi-layer structure 100. Hence the pressure withstood by the biological material layer 1 is much smaller than that of the conventional techniques, so that the biological material layer 1 is not damaged by the pressure and temperature in the die. As a result, the multi-layer structure 100 and substrate 5 can form a bonding between them with longer lifespan. Moreover, the female cavity 92 may have at least one texture 93 formed thereon. Through the pressure of the die, the outer surface of the outer layer 2 can form a three-dimensional texture to further improve the profile appeal and touch feeling of the multi-layer structure 100.

While the invention has been described by means of specific embodiment, numerous modifications and variations could be made thereto by those skilled in the art without departing from the scope and spirit of the invention set forth in the claims.

In summation of the above description, the present invention provides a significant improvement over the conventional techniques and complies with the patent application requirements, and is submitted for review and granting of the commensurate patent rights.

What is claimed is:

1. A multi-layer structure including a buffer layer to coupled with a substrate in a die, comprising:
a biological material layer including at least one first surface;
a bonding layer attached to the first surface; and
a thermoplastic buffer layer which is boned with the bonding layer and includes a compressed surface to withstand high pressure to be bonded with the substrate by fusion.

2. The multi-layer structure of claim 1, wherein the biological material layer further includes a second surface on another side opposite to the first surface and an outer layer attached to the second surface.

3. The multi-layer structure of claim 2, wherein the outer layer is colored through a dyeing process.

4. The multi-layer structure of claim 2, wherein the outer layer is a UV curable monomer or a PU film.

5. The multi-layer structure of claim 2, wherein the outer layer is selected from the group consisting of Polyethylene terephthalate (PET), Polyethylene naphthalate (PEN), Polyethylene glycol-co-cyclohexane-1,4 dimethanol terephthalate (PETG), Thermalplastic polyurethane (TPU), Polyurethane (PU), Polypropylene (PP), Polycarbonate (PC), Amorphous polyethylene terephthalate (A-PET), Polyvinyl chloride (PVC), Acrylic, Methly-methacrylate-styrene (MS), Acrylonetrile-butadiene-styrene copolymer, Polystyrene (PS), Polyoxymethylene (POM), Nylon, and combinations thereof.

6. The multi-layer structure of claim 1, wherein the buffer layer is made of thermoplastic material and the bonding layer is a thermo-melting adhesive to cover the biological material layer in a thermal melting condition, the buffer layer being pressed and bonded to the bonding layer.

7. The multi-layer structure of claim 6, wherein the buffer layer and the bonding layer are boned by a fusion surface which is formed by condensing a mixture of the bonding layer and the buffer layer.

8. The multi-layer structure of claim 6, wherein the buffer layer is selected from the group consisting of Polycarbonate (PC), Polymethyl Methacrylate (PMMA), modified PMMA, Acrylonitrile Butadiene Styrene (ABS), Polystyrene (PS), propylene-styrene copolymer, Polyvinylchloride (PVC), polyester, and combinations thereof.

9. The multi-layer structure of claim 1, wherein the die includes a male core and a female cavity, the multi-layer structure being positioned on the female cavity, the male core and the female cavity being coupled together to allow the substrate to be injected and formed on the buffer layer.

10. The multi-layer structure of claim 9, wherein the female cavity includes at least one texture.

11. The multi-layer structure of claim 9, wherein the substrate is injected and formed at a temperature ranged from 200° C. to 300° C.

12. The multi-layer structure of claim 9, wherein the substrate is injected into the die at a pressure ranged from 180 tons to 500 tons.
